(19) United States
(12) Patent Application Publication
(10) Pub. No.: US 2022/0193820 A1
(43) Pub. Date: Jun. 23, 2022

(54) Method for Fusion Welding of One or More Steel Sheets of Press-Hardenable Steel

(71) Applicant: Baosteel Tailored Blanks GmbH, Duisburg (DE)

(72) Inventors: Jana von der Heydt, Duisburg (DE); Christian Both, Duisburg (DE); Michael Kessler, Bergheim (DE)

(21) Appl. No.: 17/600,772

(22) PCT Filed: Apr. 6, 2020
(86) PCT No.: PCT/EP2020/059776

§ 371 Date: Oct. 1, 2021

(30) Foreign Application Priority Data
Apr. 4, 2019 (DE) 10 2019 108 837.2

(51) Int. Cl. B23K 26/06; B23K 26/073; B23K 26/242; B23K 26/26; B23K 26/322

(52) U.S. Cl. CPC B23K 26/0608; B23K 26/0648; B23K 26/0732; B23K 2101/006; B23K 26/242; B23K 26/26; B23K 26/322; B23K 26/0736

(57) ABSTRACT

A method for fusion welding of one or more steel sheets (1, 2) made of press-hardened steel, preferably manganese-boron steel is disclosed. At least one of the steel sheets has a metallic coating (4) which contains aluminum, and the fusion welding is performed while filler material (11) is being fed into the molten bath (9). In order to improve the hardenability of the weld seam (14), irrespective of whether the steel sheets to be welded together are steel sheets of the same or different material grades and/or steel sheets of different sheet thicknesses, a single laser focal spot (16) with different energy distribution is generated on the molten bath by means of one or more optical elements such that the laser focal spot (16) has a smaller laser focal spot area (16.1) and a larger laser focal spot area (16.2).

### CROSS-REFERENCE TO RELATED APPLICATIONS

This application is the United States national phase of International Application No. PCT/EP2020/059776 filed Apr. 6, 2020, and claims priority to German Patent Application No. 10 2019 108 837.2 filed Apr. 4, 2019, the disclosures of which are hereby incorporated by reference in their entirety.

### BACKGROUND OF THE INVENTION

### Field of the Invention

The invention relates to a method for fusion welding one or more steel sheets made of press-hardenable steel, preferably manganese-boron steel, wherein the sheet steel or at least one of the steel sheets has a metallic coating made of aluminum, e.g. an Al—Si coating, and wherein the fusion welding is performed while filler material is being fed into the molten bath produced exclusively by means of at least one laser beam.

### Description of Related Art

Tailored plates made of sheet steel (so-called tailored blanks) are used in automotive construction to meet high crash safety requirements with the lowest possible body weight. For this purpose, individual plates or strips of different material grades and/or sheet thicknesses are joined together in a butt joint by laser welding. In this way, different points of a body component can be adapted to different loads. This means that thicker or also higher-strength sheet steel can be used in areas with high load and thinner sheets or sheets made of relatively soft deep-drawing grades can be used in other areas. Tailored sheet metal plates of this type make additional reinforcement parts on the body unnecessary. This saves material and enables the overall weight of the body to be reduced.

Sheets made of manganese-boron steel are used in modern body construction and achieve high strengths through hot forming with rapid cooling. When delivered, i.e. before hot forming, manganese-boron steels have a tensile strength of approx. 600 MPa and a ferritic-pearlitic structure. Press hardening, i.e. heating to austenitising temperature before forming and subsequent rapid cooling during or after forming, allows a completely martensitic structure to be established, which can have tensile strengths of up to 2000 MPa. Components of this type are often manufactured from what are known as tailor-welded blanks; in other words there is a connection between different sheet thicknesses and/or material grades that meet the requirements, usually by means of laser beam welding.

In the hot forming and hardening process in which the tailor-welded blanks are further processed, their weld seams should generally be hardened to the same extent as the base materials of the steel plates from which the tailor-welded blanks are made. Ensuring this can, for example, pose major challenges for the hot forming process when welding steel plates of different thicknesses, for which there is a relatively large jump in thickness at the joint. The process window (parameter window) for an adequate hardening process is then relatively small. In addition, the hardening process is sensitive and must be set very precisely, which often entails production-related restrictions for the user.

Fusion welding of hot-formable, press-hardenable steel sheets is further restricted by an aluminum surface coating. Such a coating, e.g. an aluminum-silicon coating, is usually provided in order to prevent the workpieces from scaling during hot forming. However, this surface coating has a very negative effect on the quality of weld seams. This is because the fusion welding of the coated steel sheets melts the aluminum-containing surface coating in addition to the base material, thus bringing aluminum into the weld seam. If the aluminum content in the weld seam is between 2 and 10% by weight, ferritic areas (phases) are formed which lead to a reduction in the strength of the weld seam. In such cases, the strength of the weld seam is lower than that of the base material, so failure of the respective component in the weld seam can be expected regardless of the joined sheet thickness combination.

In order to prevent ferrite formation, according to the prior art, an at least partial removal of the surface coating in the edge region of the sheet edges to be welded together is carried out before the welding process by means of mechanical tools or laser beam removal (see EP 2 007 545 B1). However, for this partial removal of the surface coating, an additional process step is required, which is both costly and time-consuming and thus reduces the cost-effectiveness of the production of components of the type described here.

US 2008/0011720 A1 describes a laser-arc hybrid welding method in which plates made of manganese-boron steel, which have an surface layer that contains aluminum, are joined together in a butt joint. The arc is generated by a tungsten welding electrode or forms at the tip of a filler wire when an MIG welding torch is used. The filler wire may contain alloy elements (e.g. Mn, Ni and Cu) that induce the conversion of the steel into an austenitic structure and promote the maintenance of the austenitic conversion in the molten bath. This hybrid welding procedure is intended to enable hot-formable manganese-boron-steel plates coated with an Al—Si-based coating to be welded without prior removal of the coating material in the area where the weld seam is to be produced, whereby it should nevertheless be ensured that aluminum located at the butt joints of the plates does not lead to a reduction in the tensile strength of the component in the weld seam. By providing an electric arc behind the laser beam, the molten bath is to be homogenised and thus local aluminum concentrations greater than 1.2% by weight which generate a ferritic microstructure are to be eliminated.

This known hybrid welding method consumes a relatively high level of energy due to the generation of the electric arc. Furthermore, the welding speed is comparatively low. In addition, a weld seam produced by laser arc hybrid welding has a weld shape that is unfavourable for further forming, which may require reworking.

A method for laser beam welding of sheets of press-hardenable manganese-boron steel in a butt joint using filler wire is known from EP 2 919 942 B1, wherein the filler wire contains at least one alloy element from a group comprising manganese, chromium, molybdenum, silicon and/or nickel which promotes the formation of austenite in the molten bath generated by the laser beam, and wherein this at least one alloy element is present in the filler wire with a mass proportion of at least 0.1% by weight greater than in the press-hardenable steel of the steel sheets. The filler wire has the following composition: 0.05 to 0.15% by weight C, 0.5 to 2.0% by weight Si, 1.0 to 2.5% by weight Mn, 0.5 to 2.0% by weight Cr+Mo, and 1.0 to 4.0% by weight Ni, with the remainder iron and unavoidable impurities. In addition, the filler wire has a proportion of carbon mass that is at least 0.1% by weight lower than the press-hardenable steel of the steel sheets. The method is also characterized in that the steel sheets used are uncoated or have been partially stripped by removal of their coating in the edge region along the butt edges to be welded together before welding.

EP 2 737 971 A1 describes a laser beam welding method for the manufacture of tailor-welded blanks from coated steel sheets using filler wire, wherein the steel sheets consist of boron-alloyed steel and have an aluminum-silicon or zinc coating. The filler wire contains carbon or manganese, wherein the mass proportion of this element in the filler wire is greater than in the base material of the coated steel sheets. Thus, the carbon content of the filler wire should be 0.1 to 0.8% by weight and its manganese content 1.5 to 7.0% by weight higher than that of the base material of the steel sheets. This is to avoid a reduction in the strength of the weld seam compared to the press-hardened steel sheets as a result of the penetration of coating material into the molten bath generated by the laser beam.

EP 2 736 672 B1 discloses a method for manufacturing a component from coated steel sheets by laser beam welding using filler wire, wherein the steel sheets have a coating based on aluminum, which was removed in edge regions along the joint edges to be welded together before welding to such an extent that an intermetallic alloy layer remains there. The filler wire has the following composition: 0.6 to 1.5% by weight C, 1.0 to 4.0% by weight Mn, 0.1 to 0.6% by weight Si, max. 2.0% by weight Cr, and max. 0.2% by weight Ti, with the remainder iron and impurities caused by processing.

DE 10 2017 120 051 A1 discloses a method for laser beam welding of steel sheets made of press-hardenable manganese-boron steel, in which at least one of the steel sheets has an aluminum coating. Laser beam welding is carried out by feeding filler wire into the molten bath produced exclusively by means of a laser beam, wherein the filler wire contains at least one austenite-stabilising alloy element. In order to ensure that the weld seam has a similar strength to the base material after pressing with relatively low energy consumption and high productivity, the laser beam is set to oscillate in such a way that it oscillates transversely to the welding direction, wherein the oscillation frequency is at least 200 Hz. The method offers cost advantages as it eliminates the need to remove the aluminum coating on the edge of the sheet metal edges to be welded. However, the oscillation of the laser beam reduces the welding speed that can be achieved.

### SUMMARY OF THE INVENTION

The object of the present invention is to specify a method of the type mentioned at the outset by means of which steel sheets, of which at least one sheet is manufactured from press-hardenable steel and has a metallic coating containing aluminum, can be joined such that their weld seam after hot forming (press hardening) has a strength and hardness comparable to the base material, wherein the method should be characterized by high productivity and comparatively low energy consumption. In particular, a method of the type mentioned at the outset is to be specified by means of which the hardenability of the weld seam is improved, irrespective of whether the steel sheets to be welded together are steel sheets of the same or different material grade and/or steel sheets of different sheet thicknesses. Furthermore, the plant engineering effort required to implement the method should be relatively low. Thus, a method of the type mentioned at the outset is to be created with which sheets made of press-hardenable steel, which have a coating based on aluminum, can be economically welded together and with which the hardenability of the weld seam is improved such that the process window for an adequate hardening process is increased. In particular, a high welding speed should be made possible.

In the case of a laser beam welding method of the type mentioned at the outset, the invention provides for a single laser focal spot with different energy distribution to be generated by means of one or a plurality of optical elements on the molten bath such that the laser focal spot has a smaller laser focal spot area and a larger laser focal spot area, wherein the larger laser focal spot area irradiates a surface which is at least twice, preferably at least three times, of a surface irradiated by the smaller laser focal spot area and a higher laser energy per surface unit is introduced in the smaller laser focal spot area than in the larger laser focal spot area.

The energy distribution described according to the invention in the laser focal spot has the effect that the temperature distribution and thus the flows in the molten bath change compared to the temperature distribution and flows in a molten bath generated with a conventional laser welding beam. The smaller laser focal spot area, which can also be referred to as the main focal spot and in which a higher laser energy output per surface unit is introduced than in the larger laser focal spot area (ancillary focal spot), is essentially used for deep welding, while the larger laser focal spot area supports the welding process. The laser energy output introduced over the smaller laser focal spot area can have the same or roughly the same level as the laser energy output introduced over the larger laser focal spot area. For example, a laser energy output of approx. 4.5 kW can be guided in both the smaller laser focal spot area and the larger laser focal spot area. However, it is also in the context of the invention that the laser energy output introduced via the smaller laser focal spot area has a significantly different level than the laser energy output introduced via the larger laser focal spot area. The energy introduced in the larger laser focal spot area is distributed over a larger surface area than the energy introduced in the smaller laser focal spot area. The effect of the energy introduced in the larger laser focal spot area (ancillary focal spot) is therefore different to the effect of the energy in the main focal spot. Through this different energy input or energy distribution, a higher homogenisation of the molten bath and thus an improved weld seam in terms of its hardenability can be achieved. The process window for an adequate hardening process is thereby increased.

The energy distribution is controlled in such a way that the smaller laser focal spot area (main focal spot) generates a deep welding process, while the energy of the outer or larger laser focal spot area does not exceed the energy threshold for deep welding. The threshold range is, for example, at a power density of approx. 1,000 kW/cm2.

In particular, the method according to the invention offers the advantage that it does not require a partial removal of the surface coating containing aluminum in the edge region of the sheet edges to be welded together before the welding process. Accordingly, a preferred embodiment of the method according to the invention provides for this to be carried out essentially without prior removal, in particular without prior partial removal of the surface coating containing aluminum from the edge region of the sheet edges to be welded together.

Compared to laser beam welding after prior stripping of the edges of the coated steel sheets to be welded in the butt joint, the method according to the invention enables optimised weld seam geometry, namely a larger load-bearing metal sheet cross-section. This is particularly advantageous for subsequent dynamic loads on the weld seam.

Another advantage of the method according to the invention, as has been demonstrated in internal tests, is the significantly lower formation of weld spatter. One reason for the lower weld spatter formation is seen by the inventors in the specifically different energy distribution in the laser focal spot and the resulting special molten bath flow.

The laser beam energy can be distributed largely variably in the laser focal spot. The different energy distribution or adapted energy input in the laser focal spot is achieved in the method according to the invention by means of one or a plurality of optical elements. For example, this can be achieved via one or a plurality of diffractory or refractory optical elements and/or directly by the use of one or a plurality of correspondingly arranged optical fibres. A correspondingly modified laser welding head can for example have two different diffractory or refractory optical elements, in particular lenses, which can be displaced relative to one another in an axial and/or radial direction. A correspondingly modified laser welding head can be realised in a compact design.

Another possibility for generating a different energy distribution in the individual laser focal spot is to divide the laser beam and channel the partial laser beams thus obtained through different diffractory or refractory optical elements, in particular lenses, wherein the partial laser beams modulated in this way are then merged again into a laser beam and the laser beam thus composed is directed at the fitting joint of the steel sheet edges to be welded together. A modified laser welding head of this type can also be realised in a compact design.

Another possibility for generating a different energy distribution in the individual laser focal spot is to combine two or more different laser beams which are generated for example by means of similar or different laser light sources in a laser beam optic such that the resulting laser beam generates a single, composite laser focal spot with different energy distribution.

The device for guiding the laser welding head or the respective workpiece to be welded can in each case be designed in a conventional manner in the previously specified embodiments of the invention, i.e. the method according to the invention does not require a more complex mechanical arrangement or more complex guide device than is the case with conventional laser welding systems for carrying out a method according to the class for the fusion welding of one or a plurality of steel sheets made of press-hardened steel. A system for laser arc hybrid welding, such as that known from US 2008/0011720 A1, on the other hand, requires a relatively complex mechanical arrangement and guidance of the welding device or the workpiece to be welded due to the longer contact area of the welding device, in particular when welding along a curved sheet edge contour. A relatively small molten bath and correspondingly fine weld seams can be produced with the method according to the invention. The welding method according to the invention is distinguished by low susceptibility to errors and high process stability.

Furthermore, the method according to the invention enables high welding speeds with relatively low energy consumption, in particular in comparison with laser arc hybrid welding.

An advantageous embodiment of the invention is characterized in that the laser beam is essentially free of oscillation during fusion welding. Essentially free of oscillation means that the laser beam is not deliberately set into oscillation. In particular, relatively high welding speeds can be achieved as a result. Furthermore, the storage of the laser welding head or the holder of the optical elements in the laser welding head can thus be achieved relatively easily.

A further advantageous embodiment of the invention provides that the optical element(s) by means of which the laser focal spot having a different energy distribution is produced, is/are designed such that the position of the smaller laser focal spot area within the larger laser focal spot area can be adjusted relative to the latter. Thus, the different energy input or different energy distribution in the laser focal spot can be optimally adapted to the respective welding conditions. For example, the position of the smaller laser focal spot area within the larger laser focal spot area is adjusted in a direction running parallel and/or transverse to the welding direction. Preferably, the position of the smaller laser focal spot area within the larger laser focal spot area is set such that the smaller laser focal spot area is arranged essentially in the middle of the larger laser focal spot area or, viewed in the welding direction, in front of the centre of the larger laser focal spot area.

The shape of the larger laser focal spot area and/or the smaller laser focal spot area can for example be round, elliptical, square or rectangular. An essentially round shape of the larger laser focal spot area and/or the smaller laser focal spot area can result in particular if in the method according to the invention the different energy distribution or adapted energy input in the laser focal spot is achieved by means of one or a plurality of correspondingly arranged optical fibres.

According to an advantageous embodiment of the invention, the larger laser focal spot area has an elongated shape, in particular an oval, elliptical or rectangular shape, wherein a longitudinal axis of the larger laser focal spot area runs essentially in the welding direction. This results in a relatively large molten bath surface at the fitting joint, such that at a certain welding speed more time is available for outgassing the molten bath until the weld seam solidifies.

A further advantageous embodiment of the invention is characterized in that the larger laser focal spot area has a longitudinal extension which is at least twice, preferably at least 2.5 times, particularly preferably at least 3 times the average diameter or the largest diameter of the smaller laser focal spot area. Experiments on the part of the inventors have shown that a very homogeneous distribution of aluminum flowing into the molten bath and remaining in the weld seam can be achieved in this way.

According to the invention, fusion welding is carried out by means of filler material (also known as filler metal) in the molten bath produced exclusively by means of at least one laser beam. The filler metal has several tasks. On the one hand, the ferrite-forming effect of aluminum flowing from the coating into the welding melt can be minimised by suitable alloy elements of the filler metal and thus the hardenability of the weld seam can be improved. On the other hand, the addition of essentially aluminum-free filler material minimizes the aluminum content of the weld seam. In addition, increased or stronger flow movements in the molten bath occur due to the filler material introduced therein and thus a homogenisation of the weld seam composition.

Filler material is preferably supplied to the molten bath in the form of a wire or powder. Filler material in the form of a wire can be fed into the molten bath in a highly energy efficient manner and with high quantity accuracy. By introducing a powdered filler metal of a suitable particle size, a very uniform mixing of the filler metal in the molten bath is possible. Typically, the duration of the fusion phase during laser welding is in a range of only about 6 ms to 125 ms. Since the welding time for laser welding is relatively short, powdered filler metal can be used to achieve better mixing with the steel to be welded than with the use of filler wire. Through the use of a powdered filler metal, which has relatively small particles, preferably small metal particles, a largely homogeneous alloy mixture can also be achieved in very short time periods in the melting phase. The particles of the powdered filler metal have, for example, a particle size in the range from 20 μm to 160 μm, preferably in the range from 20 μm to 160 μm.

Preferably, the powdered filler material is supplied in the form of a gas powder flow via at least one flow channel, wherein the gas powder flow emerging from the flow channel is directed towards the molten bath and has an exit speed of at least 2 m/s, preferably at least 10 m/s, particularly preferred at least 15 m/s, such that a turbulent mixing of the filler metal with the molten bath results in flow vortices in the molten bath. These flow vortices (turbulences) are caused in particular by the kinetics of the gas powder flow. An upper limit of the outlet speed of the gas powder flow directed at the molten bath can for example be 50 m/s, in particular 40 m/s or 30 m/s.

The filler material supplied to the molten bath when carrying out the method according to the invention is preferably essentially aluminum-free. In the context of the invention, an aluminum-free or essentially aluminum-free additive is understood to mean a filler metal that does not contain any aluminum except for unavoidable impurities or unavoidable trace amounts.

In order to improve the hardenability of the weld seam, a further embodiment of the invention envisages the filler material containing at least one alloy element of a group comprising nickel, chromium and/or carbon. In order to increase the hardenability of the weld seam, the filler material preferably contains 5 to 12% by weight Ni, 5 to 25% by weight Cr and 0.05 to 0.4% by weight C, optionally at least one further alloying element, with the remainder being iron and unavoidable impurities. A chromium content of the filler material in the range of 5 to 25% by weight is favourable in order to reduce the critical cooling speed of the weld seam and thus further improve the hardenability of the weld seam.

A preferred embodiment of the method according to the invention is characterized in that the filler material used here has the following composition: 0.05 to 0.4% by weight C, 0 to 2.0% by weight Si, 0 to 3.0% by weight Mn, 4 to 25% by weight Cr, 0 to 0.5% by weight Mo, and 5 to 12% by weight Ni, with the remainder being Fe and unavoidable impurities. Internal tests have shown that a filler material of this type can very reliably ensure a complete conversion of the weld seam into a martensitic structure during subsequent hot forming (press hardening) of the tailored blank using the method according to the invention.

A further advantageous embodiment of the method according to the invention is characterized in that the filler material, preferably in the form of a wire, is fed into the molten bath in such a manner that the filler material is fed directly into the smaller laser focal spot area. The filler material, preferably in the form of a wire, thereby touches the smaller laser focal spot area or is essentially directed at the smaller laser focal spot area. This ensures that the molten filler material flows around the steam capillary in the molten bath during deep welding. As a result, a better mixing of the filler material with the sheet steel material melted in the fitting joint, i.e. butt joint or lap joint, and thus a more homogeneous weld seam is achieved.

A further advantageous embodiment of the method according to the invention is characterized in that the filler material, preferably in the form of a wire, is supplied in a dragging manner. A dragging filler material feed, in particular wire feed, means that the filler material, when considered in the welding direction, is fed in advance to the molten bath or to the smaller laser focal spot area from the front. This configuration also achieves a better mixing of the filler material with the sheet steel material melted in the fitting joint, i.e. butt joint or lap joint, and thus a more homogeneous weld seam.

A further advantageous embodiment of the method according to the invention is characterized in that the filler material supplied in the form of a wire is fed into the molten bath in such a way that the central axis of the wire with the surface of the at least one steel sheet to be welded or the steel sheets to be welded together encloses an acute angle of less than 50°, preferably less than 45°, particularly preferably less than 30°, in particular between 10° and 30°. As a result, an optimum feed of the filler material into the deep welding area, in particular in the direction of the steam capillary, can be achieved.

According to a further advantageous embodiment, the filler material, preferably in the form of a wire, is heated to a temperature of at least 60° C., preferably to at least 100° C., preferably to at least 150° C., in particular to at least 180° C. by means of a heating device before it is fed into the molten bath. This enables a significantly higher welding speed compared to the use of a non-heated filler wire. The tip of the heated filler wire can be melted more quickly with the laser beam. Furthermore, the welding process becomes more stable by heating the filler wire before feeding it into the welding melt. The upper limit of the temperature of the pre-heated wire is below the temperature at which the wire loses its dimensional stability or this becomes too low for reliable wire feed. The upper limit of the wire pre-heating is, for example, in the range of approx. 250° C. to 300° C.

A manganese-boron steel is preferably used as press-hardenable steel. In a preferred embodiment of the method according to the invention, the steel sheet to be welded or at least one of the steel sheets to be welded together is selected such that it has a press-hardenable steel of the following composition: 0.10 to 0.50% by weight C, max. 0.40% by weight Si, 0.50 to 2.0% by weight Mn, max. 0.025% by weight P, max. 0.010% by weight S, max. 0.60% by weight Cr, max. 0.50% by weight Mo, max. 0.050% by weight Ti, 0.0008 to 0.0070% by weight B, and at least 0.010% by weight Al, with the remainder consisting of Fe and unavoidable impurities. The components manufactured from a sheet steel of this type exhibit a high level of strength after press hardening. Sheets made of different or identical manganese-boron steels can be welded together with the method according to the invention in order to provide tailor-made semi-finished sheet metals with maximum strengths through press hardening.

The method according to the invention can not only be used for joining several steel plates of the same or different sheet thicknesses in a butt joint, of which at least one plate is manufactured from press-hardened steel and provided with an aluminum-containing coating, but can also be used for laser beam welding of a single plate or strip-shaped sheet steel made from press-hardened steel, preferably manganese-boron steel, which has a coating containing aluminum, wherein in the latter case the sheet metal edges to be welded together are moved towards one another by forming, for example by bending or roll-forming, such that they are finally arranged opposite one another in the butt joint.

Furthermore, the method according to the invention can also be used in the laser beam welding of one or a plurality of steel sheets made of press-hardened steel, preferably manganese-boron steel, in a lap joint.

A further advantageous embodiment of the method according to the invention is characterized in that the steel sheet(s) is/are joined in the butt joint, wherein a gap to be joined is set as small as possible, preferably quasi a “technical zero gap”, with an average gap width in the range from 0.01 to 0.15 mm, preferably in the range from 0.06 to 0.15 mm.

A further preferred embodiment of the method according to the invention provides for the steel sheet(s) to be joined with a welding speed of at least 4 m/min, preferably of at least 5 m/min, particularly preferably with a welding speed in the range of 6 to 12 m/min.

In order to achieve a weld seam that is as homogeneous as possible and can be hardened without any problems as well as a very good weld seam geometry, it is advantageous if, according to a further preferred embodiment of the method according to the invention, the filler material is supplied in the form of a wire, wherein the wire is fed in at a feed speed in the range of 40% to 90% of the welding speed.

A further embodiment of the invention envisages the fusion bath being exposed to protective gas during laser welding at least on the side facing away from the laser beam. The shielding gas protects the welding melt from oxidation, which would weaken the weld seam. The protective gas can for example be pure argon, CO_{2,} helium, nitrogen or a mixed gas of argon, helium, nitrogen and/or CO₂.

A further advantageous embodiment of the invention envisages the molten bath not being exposed to a protective gas flow during laser welding at least on its side facing the laser beam. Experiments on the part of the inventors have shown that this can significantly reduce the occurrence of weld spatter.

### BRIEF DESCRIPTION OF THE DRAWINGS

The invention is explained in more detail in the following with reference to a drawing illustrating exemplary embodiments. The drawings show schematically the following:

FIG. 1 shows a perspective view of parts of a device for carrying out the fusion welding method according to the invention, wherein two press-hardenable steel sheets of essentially the same thickness are welded together in a butt joint using filler wire by means of a laser beam;

FIG. 2 shows a perspective view of parts of a device for carrying out the fusion welding method according to the invention, wherein two press-hardenable steel sheets of essentially different thicknesses are welded together in a butt joint using filler wire by means of a laser beam;

FIG. 3 shows a perspective view of parts of a further device for carrying out the fusion welding method according to the invention, wherein two press-hardenable steel sheets of essentially the same thickness are welded together in a butt joint using filler wire by means of a laser beam;

FIG. 4a shows a planar view of a laser focal spot generated when carrying out the method according to the invention; and

FIG. 4b shows a planar view of a further laser focal spot generated when carrying out the method according to the invention.

### DETAILED DESCRIPTION OF PREFERRED EMBODIMENTS

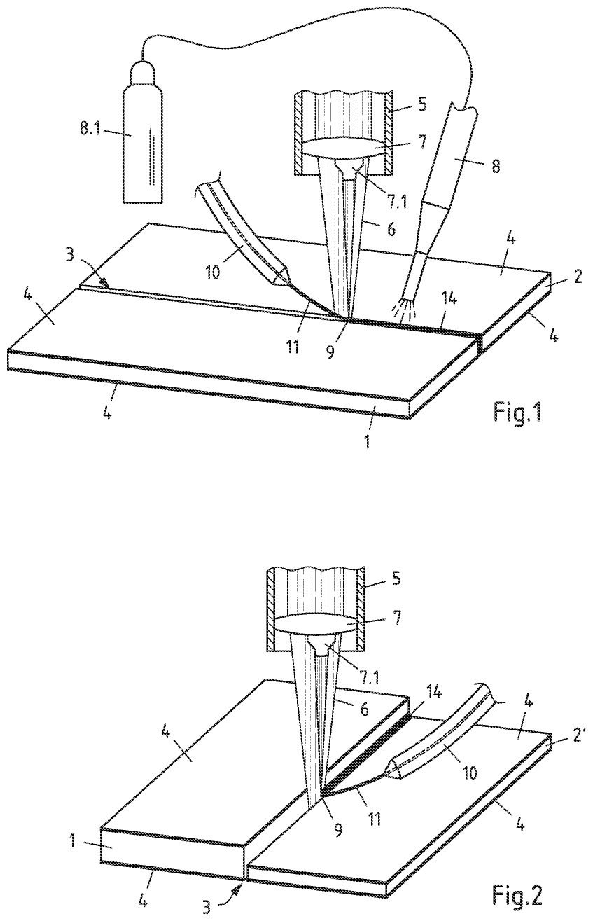

Laser beam welding devices for carrying out the method according to the invention are sketched in FIGS. 1 to 3. The respective device comprises a base (not shown), on which two strips or plates 1, 2 made of steel of the same or different material grade are arranged such that their edges to be welded together are arranged in a butt joint. At least one of the steel sheets 1, 2 is made of press-hardenable steel, preferably manganese-boron steel. The steel sheets 1, 2 are joined with the smallest possible gap 3 of a few tenths of a millimeter in the butt joint. For example, the width of the gap 3 is less than 0.2 mm, preferably less than 0.15 mm. If the steel sheets 1, 2 are manufactured from steel of different material grades, one steel sheet 1 or 2 has, for example, a relatively soft deep-drawing grade, while the other steel sheet 2 or 1 consists of higher-strength steel.

The press-hardenable steel, of which of at least one of the steel sheets 1, 2 to be connected to one another consists, can for example have the following chemical composition:
0.10 to 0.50% by weight C,
max. 0.40% by weight Si,
0.50 to 2.0% by weight Mn,
max. 0.025% by weight P,
max. 0.010% by weight S,
max. 0.60% by weight Cr,
max. 0.50% by weight Mo,
max. 0.050% by weight Ti,
0.0008 to 0.0070% by weight B, and
min. 0.010% by weight Al,
the remainder consisting of Fe and unavoidable impurities.

In delivery condition, i.e. before heat treatment and rapid cooling, the press-hardenable steel sheet 1 or 2 has a yield strength Re of preferably at least 300 MPa; its tensile strength Rm is, for example, at least 480 MPa, and its elongation at fracture A₈₀ is preferably at least 10%. After hot forming (press hardening), i.e. heating to austenitising temperature of approx. 900° C. to 950° C., forming at this temperature and then rapid cooling, the press-hardened sheet steel has a yield strength Re of approx. 1,100 MPa, a tensile strength Rm of approx. 1,500 MPa to 2,000 MPa and an elongation at fracture A₈₀ of approx. 5%.

The steel sheets 1, 2 are provided with a metallic coating 4 made of aluminum. This is, for example, an Al—Si coating. The coating 4 is preferably applied to the base material on both sides, for example by hot-dip coating, in which a strip of press-hardenable steel, preferably manganese-boron steel, is guided through an Al—Si molten bath, excess coating material is blown off the strip and the coated strip is subsequently treated, in particular heated. The aluminum content of the coating 4 can be in the range of 70% by weight to 90% by weight.

Alternatively, only one of the steel sheets 1, 2 to be welded can have an aluminum-containing coating 4. Furthermore, the coating 4 can, if necessary, only be applied to one side of the steel sheet(s) 1, 2, e.g. by means of physical vapour deposition (PVD) or by means of an electrolytic coating process.

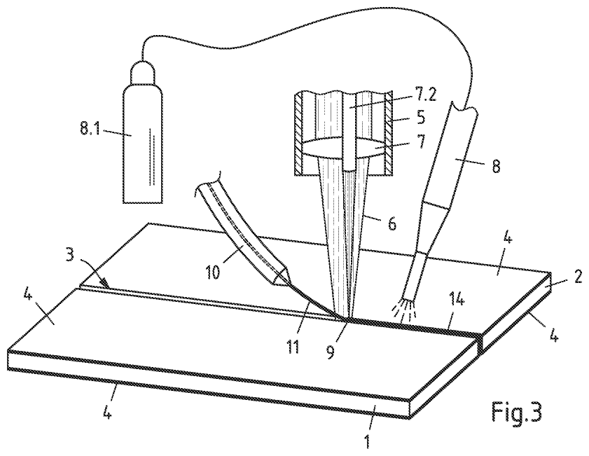

The steel sheets 1, 2 can, as shown in FIGS. 1 and 3, be essentially the same thickness. The sheet thickness is, for example, in the range of 0.8 to 3.0 mm, preferably in the range of 1.8 mm to 3.0 mm, while the thickness of the metallic surface coating 4 on the respective sheet side can be less than 100 μm, in particular less than 50 μm.

Above the steel sheets 1, 2, a section of a laser welding head 5 is shown, which is provided with optics for the shaping and alignment of a laser beam 6, in particular a focussing lens 7. The laser beam 6 is generated, for example, by means of an Nd:YAG laser system, which provides power in the range of 5 kW to 10 kW.

A line 8 for the supply of shielding gas can optionally be assigned to the laser welding head 5. The mouth of the protective gas line 8 is or is for example essentially directed at the freshly generated section of the weld seam 14 in such a way that the molten bath 9 itself is not, or at least is not directly, exposed to the protective gas flow. 8.1 is a compressed gas tank serving as a protective gas source. Pure argon or, for example, a mixture of argon, helium and/or carbon dioxide is preferably used as a protective gas. An alternative or further configuration (not shown) of the fusion welding method envisages the underside or the side of the molten bath 9 facing away from the laser beam 6 and the underside of the weld seam 14 being exposed to protective gas.

Furthermore, a guide line 10 is assigned to the laser welding head 5 by means of which filler material (filler metal) 11 is supplied to the molten bath 9 for example in the form of a wire, wherein the tip of the wire 11 melts in the molten bath 9. The filler metal 11 essentially does not contain any aluminum. It has, for example, the following chemical composition:
0.05 to 0.4% by weight C,
0 to 2.0% by weight Si,
0 to 3.0% by weight Mn,
4 to 25% by weight Cr,
0 to 0.5% by weight Mo, and
5 to 12% by weight Ni,
the remainder consisting of Fe and unavoidable impurities.

Instead of a wire-shaped filler metal (filler wire) 11, a powdered filler metal in the form of a gas powder flow can also be supplied to the molten bath 9. The powdered filler metal can have the same chemical composition as the filler wire 11 described above. One of the above-mentioned protective gases is preferably used as carrier gas for feeding the powdered filler metal into the molten bath 9.

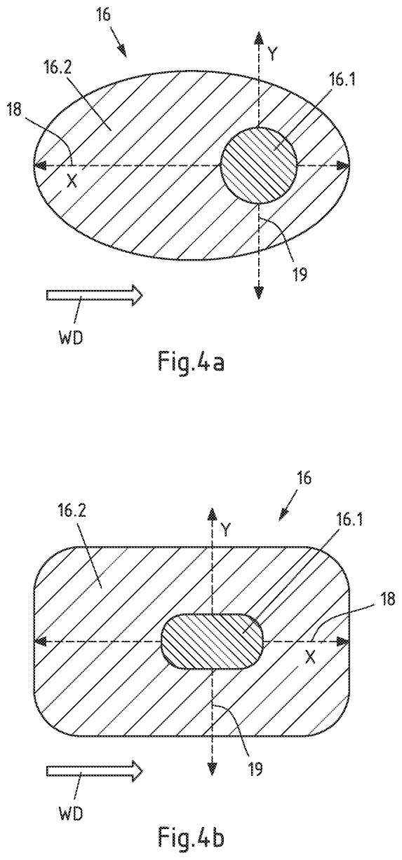

According to the invention, the laser welding head 5 has one or a plurality of optical elements by means of which a single laser focal spot 16 with different energy distribution on the molten bath 9 is generated such that the laser focal spot 16 has a smaller laser focal spot area 16.1 and a larger laser focal spot area 16.2 (see also FIGS. 4a and 4b). The larger laser focal spot area 16.2 irradiates a surface which is at least 2 times, preferably at least 3 times, of a surface irradiated by the smaller laser focal spot area 16.1, wherein a higher laser energy output per surface unit is introduced in the smaller laser focal spot area 16.1 than in the larger laser focal spot area 16.2. The smaller laser focal spot area 16.1 and the larger laser focal spot area 16.2 can have different energy levels, which are independent of one another. For example, both the smaller laser focal spot area 16.1 and the larger laser focal spot area 16.2 can have a laser energy output in the range of 4 kW to 5 kW, whereby this energy or output is distributed over a significantly larger area in the larger laser focal spot area 16.2. The smaller laser focal spot area 16.1 is essentially used for deep welding, while the larger laser focal spot area 16.2 supports the welding process.

The larger laser focal spot area 16.2 has an elongated shape, for example an oval, elliptical or rectangular shape. Its longitudinal axis runs essentially in the respective welding direction WD, i.e. essentially parallel thereto. The smaller laser focal spot area 16.1 can have an essentially circular shape or also an elongated shape (see FIGS. 4a and 4b).

The optical element(s) of the laser welding head 5, by means of which the laser focal spot having a different energy distribution is generated, can for example be a diffractory or refractory optical element assigned to the focussing lens 7 and/or a smaller additional focussing lens 7.1 (see FIGS. 1 and 2).

Another possibility for generating a single laser focal spot 16 with different energy distribution is shown in FIG. 3. The laser welding head 5 shown there schematically has a focussing lens 7 with a light guide or light fibre bundle 7.2 associated thereto.

Preferably, the optical elements 7, 7.1 or 7, 7.2 of the laser welding head 5 are designed in such a way that the position of the smaller laser focal spot area 16.1 can be adjusted within the larger laser focal spot area 16.2 relative to the latter. For example, the position of the smaller laser focal spot area 16.1 within the larger laser focal spot area 16.2 can be adjusted in a direction running parallel and/or transverse to the welding direction WD (X direction and/or Y direction). This adjustment option is schematically indicated in FIGS. 4a and 4b by dashed double arrows 18, 19. For example, the smaller focussing lens 7.1, the at least one diffractory or refractory optical element or the light guide 7.2 is mounted in the laser welding head 5 radially adjustable to the focussing lens 7.

If the different energy distribution in the laser focal spot is achieved by means of a focussing lens 7 and a light guide or light fibre bundle 7.2 assigned to the focussing lens, the position of the laser focal spot areas 16.1 and 16.2 relative to one another can for example be varied by defocussing the laser beam 6.

Furthermore, it can be seen in FIG. 4a as well as in FIG. 4b that the larger laser focal spot area 16.2 has a longitudinal extension which is at least 2 times, preferably at least 2.5 times, particularly preferably at least 3 times the average diameter or the largest diameter of the smaller laser focal spot area 16.1.

The exemplary embodiment shown in FIG. 2 differs from the examples shown in FIGS. 1 and 3 in that the steel sheets 1, 2′ are of different thicknesses such that a thickness step d is present on the butt joint. For example, one sheet 2′ has a sheet thickness in the range of 0.8 mm to 1.2 mm, while the other sheet 1 has a sheet thickness in the range of 1.6 mm to 3.0 mm. In addition, the steel sheets 1, 2′ to be joined together in the butt joint can also differ in their material quality. For example, the thicker plate 1 is made of higher-strength steel, whereas the thinner steel plate 2′ has a relatively soft deep-drawing quality. The steel sheets 1, 2′ are also joined together with the smallest possible gap 3 of a few tenths of a millimetres.

In FIG. 2, as illustrated in the embodiment, during laser welding, the molten bath 9 is not exposed to a protective gas flow on its side facing the laser beam 6. However, the side of the molten bath 9 facing away from the laser beam 6 and the side of the weld seam 14 facing away from the laser beam 6 are preferably supplied with protective gas.

The described special or adapted energy distribution in the individual laser focal spot 16 has the effect that the temperature distribution and thus the flows in the molten bath 9 change. This results in better homogenisation of the weld seam 14. Welding speeds of 5 m/min and more are thereby advantageous for the homogeneity of the weld seam 14. The filler wire 11 is preferably fed at a speed of 40% to 90% of the welding speed.

The filler wire 11 is fed into the molten bath 9 preferably in such a way that the wire 11 touches the smaller laser focal spot area 16.2 or is directed essentially directly at the smaller laser focal spot area 16.2. In addition, the wire feed is preferably in a dragging manner (see FIG. 1 and FIG. 3).

Furthermore, it can be seen in FIGS. 1 to 3 that the filler wire 11 is fed into the molten bath 9 in such a way that the central axis of the wire 11 with the surface of the at least one steel sheet 1, 2 to be welded or of the steel sheets 1, 2 to be welded together encloses an acute angle, which for example lies in a range of 10° to 45°, preferably in the range between 10° and 30°.

The implementation of the invention is not limited to the exemplary embodiments schematically represented in the drawing. Instead, numerous variants are conceivable that also make use of the invention specified in the attached claims in the case of a design deviating from the examples shown. For example, it is also possible in the context of the invention for the filler material 11, in particular in the form of a wire, to be heated to a temperature of at least 60° C. by means of a heating device before flowing into the molten bath 9. For example, the filler wire 11 is heated to a temperature in the range of 100° C. to 300° C., preferably in the range of 150° C. to 250° C. before flowing into the molten bath 9.

1. A method for fusion welding of one or more steel sheets made of press-hardened steel, wherein at least one of the steel sheets has a metallic coating which contains aluminum, and wherein the fusion welding is performed while filler material is being fed into the molten bath produced by at least one laser beam, the method comprising:
generating a single laser focal spot with different energy distribution by of one or a plurality of optical elements on the molten bath such that the laser focal spot has a smaller laser focal spot area and a larger laser focal spot area,
irradiating a first surface with the larger laser focal spot area wherein the first surface is at least two times of a second surface irradiated by the smaller laser focal spot area, and
introducing a higher laser energy output per surface unit in the smaller laser focal spot area than in the larger laser focal spot area.

2. A method according to claim 1, wherein the laser beam is substantially free of oscillation during fusion welding.

3. A method according to claim 1, wherein the optical element, by which the laser focal spot having the different energy distribution is produced, is configured such that the position of the smaller laser focal spot area within the larger laser focal spot area is adjustable relative to the larger laser focal spot.

4. A method according to claim 3, wherein the position of the smaller laser focal spot area within the larger laser focal spot area is adjusted in a direction running one of parallel and transverse to a welding direction.

5. A method according to claim 1, wherein the larger laser focal spot area has an elongated shape, and wherein a longitudinal axis of the larger focal spot area runs substantially in a welding direction.

6. A method according to claim 1, wherein the larger laser focal spot area has a longitudinal extension that is at least 2 times, the average diameter or largest diameter of the smaller laser focal spot area.

7. A method according to claim 1, wherein the filler material is supplied in the form of a wire or powder.

8. A method according to claim 1, wherein the filler material does not contain any aluminum except for unavoidable impurities or unavoidable trace amounts.

9. A method according to claim 1, wherein the filler material contains at least one alloy element of a group comprising nickel, chromium, and carbon.

10. A method according to claim 1, wherein the filler material has the following composition:
0.05-0.4% by weight C,
0-2.0% by weight Si,
0-3.0% by weight Mn,
4-25% by weight Cr,
0-0.5% by weight Mo, and
5-12% by weight Ni,
the remainder consisting of Fe and unavoidable impurities.

11. A method according to claim 1, wherein the press hardened steel has the following composition:
0.10-0.50% by weight C,
max. 0.40% by weight Si,
0.50-2.0% by weight Mn,
max. 0.025% by weight P,
max. 0.010% by weight S,
max. 0.60% by weight Cr,
max. 0.50% by weight Mo,
max. 0.050% by weight Ti,
0.0008-0.0070% by weight B, and
min. 0.010% by weight Al,
the remainder consisting of Fe and unavoidable impurities.

12. A method according to claim 1, wherein the steel sheets are joined in a butt joint, wherein a gap with an average gap width in the range from 0.01 to 0.15 mm is set on the butt joint to be joined.

13. A method according to claim 1, wherein the steel sheets are joined with a welding speed of at least 4 m/min.

14. A method according to claim 1, wherein the filler material is supplied in the form of a wire, and wherein the wire is fed at a supply speed in the range of 40% to 90% of a welding speed.

15. A method according to claim 1, wherein the molten bath is not exposed to a protective gas flow during laser welding at least on a side facing the laser beam.

16. A method according to claim 1, wherein the filler material is fed into the molten bath such that the filler material is fed directly into the smaller laser focal spot area.

17. A method according to claim 1, wherein the filler material is supplied in a dragging manner.

18. A method according to claim 1, wherein the filler material supplied in the form of a wire is supplied to the molten bath in such that a central axis of the wire with a surface of the at least one steel sheet to be welded or of the steel sheets to be welded together encloses an acute angle of less than 50°.

19. A method according to claim 1, wherein the filler material is heated to a temperature of at least 60° C., by a heating device before being fed into the molten bath.
